(19) United States
(12) Patent Application Publication
(10) Pub. No.: US 2023/0081186 A1
(43) Pub. Date: Mar. 16, 2023

(54) AUTONOMOUS VEHICLE SUPERVISED STOPS

(71) Applicant: GM Cruise Holdings LLC, San Francisco, CA (US)

(72) Inventors: Alexander Willem Gerrese, San Francisco, CA (US); Aakanksha Mirdha, San Francisco, CA (US); Ashley Sams, San Francisco, CA (US); Swarnakshi Kapil, Sunnyvale, CA (US)

(73) Assignee: GM Cruise Holdings LLC, San Francisco, CA (US)

(21) Appl. No.: 17/474,465

(22) Filed: Sep. 14, 2021

(51) Int. Cl. B60W 60/00; B60R 25/10; G06Q 50/30

(52) U.S. Cl. CPC B60W 60/00253; B60R 25/1001; G06Q 50/30; B60W 2540/21; B60W 2540/043

(57) ABSTRACT

Systems and methods are provided for adding supervised stops to an autonomous vehicle route. In particular, systems and methods are provided for allowing a primary passenger, who is accompanied by one or more other passengers, to pause a ride, exit the vehicle, and request supervision of the other passengers while the primary passenger is away from the vehicle. Supervision of the other passengers can include monitoring vehicle temperature, making sure the other passengers remain safely inside the vehicle, preventing strangers from accessing the vehicle, providing any requested feedback regarding the other passengers to the primary passenger, and enabling communication between the first passenger and the other passengers.

### FIELD OF THE DISCLOSURE

The present disclosure relates generally to autonomous vehicles (AVs) and to systems and methods for supervised stops.

### BACKGROUND

Autonomous vehicles, also known as self-driving cars, driverless vehicles, and robotic vehicles, are vehicles that use multiple sensors to sense the environment and move without human input. Automation technology in the autonomous vehicles enables the vehicles to drive on roadways and to accurately and quickly perceive the vehicle's environment, including obstacles, signs, and traffic lights. The vehicles can be used to pick up passengers and drive the passengers to selected destinations. The vehicles can also be used to pick up packages and/or other goods and deliver the packages and/or goods to selected destinations.

Autonomous vehicles are often used to provide rides to passengers who remotely request a vehicle for a selected pick up location and destination. Some passenger trip requests include multiple passengers and multiple destinations. In some examples, a trip request for multiple passengers includes a parent and one or more children, and the parent may want to stop at a first destination to run a quick errand. However, bringing the children to run the errand can be an inconvenience that can cause the parent to forgo the errand.

### SUMMARY

Systems and methods are provided for supervised stopping points on a route. In particular, systems and methods are provided for allowing a primary passenger who is accompanied by one or more other passengers, to pause a ride, exit the autonomous vehicle, and request supervision of the one or more other passengers while the primary passenger is away from the vehicle. In some examples, the primary passenger may exit the vehicle to run an errand. While the ride is paused, the autonomous vehicle provides supervision for the other passengers, including one or more of monitoring vehicle temperature, making sure the other passengers remain safely inside the vehicle, preventing strangers from accessing the vehicle, providing any requested feedback regarding the other passengers to the primary passenger, enabling communication between the first passenger and the other passengers, and continuing in-vehicle entertainment. The autonomous vehicle picks up the primary passenger after the stop and continues along the route to another stop and/or to the final destination.

According to one aspect, a method for adding supervised stops to an autonomous vehicle route is provided, comprising receiving a ride request including a pick-up location and a destination location; picking up a plurality of passengers at the pick-up location, wherein the plurality of passengers include a primary passenger and a secondary passenger; receiving a supervised stop request including a stop location; dropping off a primary passenger at the stop location for a selected stop duration; and supervising a secondary passenger during the stop duration, wherein supervising the secondary passenger includes detecting a secondary passenger event and responding to the secondary passenger event.

In some implementations, responding to the secondary passenger event includes at least one of triggering an automated response and notifying the primary passenger. In some implementations, triggering an automated response includes responding using a voice assistant intermediary. In some implementations, detecting a secondary passenger event includes passively detecting the secondary passenger event using in-cabin sensors. In some implementations, detecting a secondary passenger event includes at least one of detecting a selected word, detecting a selected phrase, and detecting noise exceeding a selected sound level threshold. In some implementations, the method further includes remotely monitoring the secondary passenger. In some implementations, the method further includes providing remote assistance to the secondary passenger.

In some implementations, the method further includes receiving secondary passenger information and second passenger supervision settings in a primary passenger rideshare account profile. In some implementations, the method further includes identifying the secondary passenger.

In some implementations, supervising the secondary passenger further includes enabling a safety feature, wherein the safety feature is activated on a primary passenger rideshare account, and wherein the safety feature includes at least one of an external door tamper alert, an internal door tamper alert, an unbuckled seatbelt alert, and an air quality alert. In some implementations, the method further includes establishing a communication link between an interior cabin of the autonomous vehicle and a primary passenger rideshare application. In some implementations, the method includes defining a geofenced area for the autonomous vehicle during the stop duration. In some implementations, the method includes establishing a connection with a passenger rideshare account and transmitting vehicle information to the passenger rideshare account.

According to another aspect, a system for addition of a supervised stop to an autonomous vehicle route is provided, comprising: a central computing system including a routing coordinator configured to: receive a ride request including a pick-up location and a destination location, and select an autonomous vehicle to fulfill the ride request; a plurality of sensors in a cabin of the autonomous vehicle; and an onboard computing system on the autonomous vehicle configured to: direct the autonomous vehicle to the pick-up location for pick up of a plurality of passengers, wherein the plurality of passengers include a primary passenger and a secondary passenger; receive a supervised stop request, wherein the supervised stop request includes a stop location and a stop duration; direct the autonomous vehicle to drop off the primary passenger at the stop location; and supervise the secondary passenger during the stop duration, wherein supervising the secondary passenger includes: detecting, based on data from the plurality of sensors, a secondary passenger event, and responding to the secondary passenger event.

In some implementations, the central computing system is further configured to receive the supervised stop request, and send the supervised stop request to the autonomous vehicle. In some implementations, the plurality of sensors are passive sensors and wherein the onboard computing system is configured to use the data from the plurality of sensors to detect the secondary passenger event by detecting at least one of a selected word, a selected phrase, and noise exceeding a selected sound level threshold. In some implementations, the onboard computing system is further configured to respond to the secondary passenger event by at least one of notifying the primary passenger and using a voice assistant intermediary to respond to the second passenger. In some implementations, the central computing system includes a database having primary passenger rideshare account information, and wherein the primary passenger rideshare account information includes secondary passenger profile information and supervision settings for supervised stops. In some implementations, the onboard computing system is further configured to identify the second passenger based on image data from the plurality of sensors and based on the secondary passenger profile information.

According to another aspect, an autonomous vehicle for providing supervision during an intermediate stop is provided, comprising: a plurality of sensors positioned within in an interior cabin; a screen configured to display video; an onboard computing system configured to: receive ride request information including a pick-up location and a destination location; direct the autonomous vehicle to the pick-up location for pick up of a plurality of passengers, wherein the plurality of passengers include a primary passenger and a secondary passenger; receive a request for a supervised stop through a primary passenger rideshare account, wherein the supervised stop request includes a stop location and a stop duration; direct the autonomous vehicle to drop off the primary passenger at the stop location; and supervise the secondary passenger during the supervised stop, wherein supervising the secondary passenger includes: detecting, based on data from the plurality of sensors, a secondary passenger event, and responding to the secondary passenger event.

In some implementations, the plurality of sensors are passive sensors and wherein the onboard computing system is configured to use the data from the plurality of sensors to detect the secondary passenger event by detecting at least one of a selected word, a selected phrase, and noise exceeding a selected sound level threshold. In some implementations, the screen is configured to provide communication between a primary passenger rideshare account and a secondary passenger during the supervised stop. In some implementations, the screen is configured to provide entertainment to the secondary passenger during the supervised stop, wherein entertainment options are based on supervised stop settings in the primary passenger rideshare account.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIGS. 1A and 1B are diagrams illustrating an autonomous vehicle, according to some embodiments of the disclosure;

FIG. 2 is a diagram illustrating a method for adding one or more supervised stops to an autonomous vehicle route, according to some embodiments of the disclosure;

FIG. 3 is a diagram illustrating a method for autonomous vehicle communication during a supervised stop, according to some embodiments of the disclosure;

FIG. 4 is a diagram illustrating a method for autonomous vehicle routing during a supervised stop, according to some embodiments of the disclosure;

FIGS. 5A-5D show examples of an interface for requesting supervised stops, according to some embodiments of the disclosure;

FIG. 6 is a diagram illustrating a fleet of autonomous vehicles in communication with a central computer, according to some embodiments of the disclosure; and

FIG. 7 shows an example embodiment of a system for implementing certain aspects of the present technology.

### DETAILED DESCRIPTION

Overview

Systems and methods are provided for supervised stops along autonomous vehicle routes. In particular, systems and methods are provided for allowing a first passenger who is accompanied by one or more other passengers, to pause a ride, exit the autonomous vehicle, and request supervision of the one or more other passengers while the first passenger is away from the vehicle. In some examples, the first passenger may exit the vehicle to run an errand, such as to pick up dry cleaning, do some shopping, or go to the bank. While the ride is paused, the autonomous vehicle provides supervision for the other passengers, including one or more of monitoring vehicle temperature, making sure the other passengers remain safely inside the vehicle, preventing strangers from accessing the vehicle, providing any requested feedback regarding the other passengers to the first passenger, enabling communication between the first passenger and the other passengers, and providing in-vehicle entertainment. While the first passenger is away and the autonomous vehicle provides the supervision of the other passengers, the autonomous vehicle may park, and/or circle the block, before returning to pick up the first passenger. The autonomous vehicle picks up the first passenger after the stop and continues along the first passenger's route to another stop and/or to the final destination.

One of the advantages of providing supervised stops is the additional flexibility it provides to users. For example, one of the most highly touted benefits of car ownership is the freedom of mobility that it enables—people with a car can easily drive to the grocery store to pick up some missing items for dinner, drop off dry cleaning during the critical period when a stain can still be removed, and drop by a friend's house for a catchup on the way back from work. However, ultimate freedom can only be achieved when driving alone. Therefore, in the cases when there are additional passengers, the realm of possible destinations usually shrinks, decreasing further for additional passengers with special needs such as young children, pets, and people with physical disabilities.

Currently, when the driver needs to run a quick errand and is accompanied by additional passengers, the driver must decide whether the errand is worth the effort of bringing along the other passengers, whether the errand is worth the risk of leaving the other passengers unaccompanied during the errand, or whether the driver should skip the errand and return to complete the errand another time. In some unfortunate cases, negligent drivers leave children and/or pets in a hot or unprotected car for long enough that the children's and/or pet's health is put in serious danger. In fact, after motor vehicle crashes, heatstroke is a leading cause of death in vehicles for children ages 14 and younger. Systems and methods are provided herein to empower the driver to make the solo stops they need while ensuring passengers who remain in the car are protected and supervised. In particular, systems and methods are provided for supervising passengers remaining in a vehicle during a stop, such that a first passenger can exit the vehicle and passengers remaining in the vehicle are supervised while the first passenger is away.

Example Autonomous Vehicle Configured for Supervised Stops

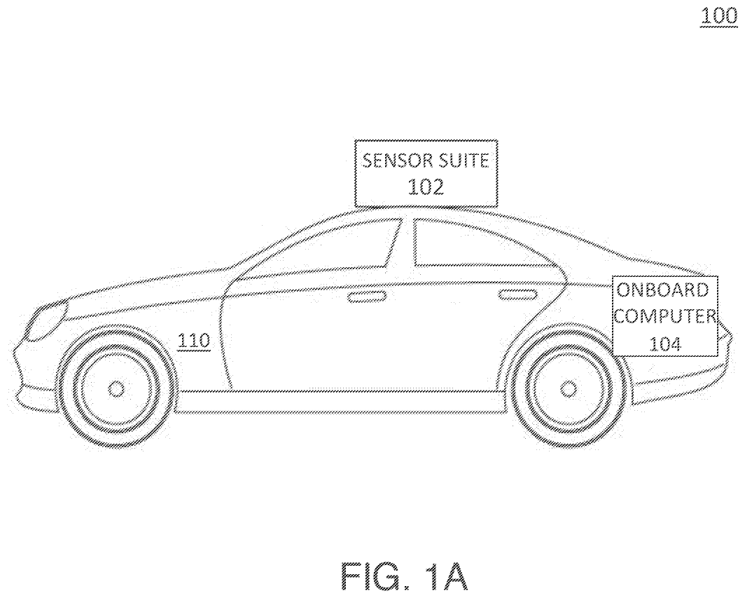

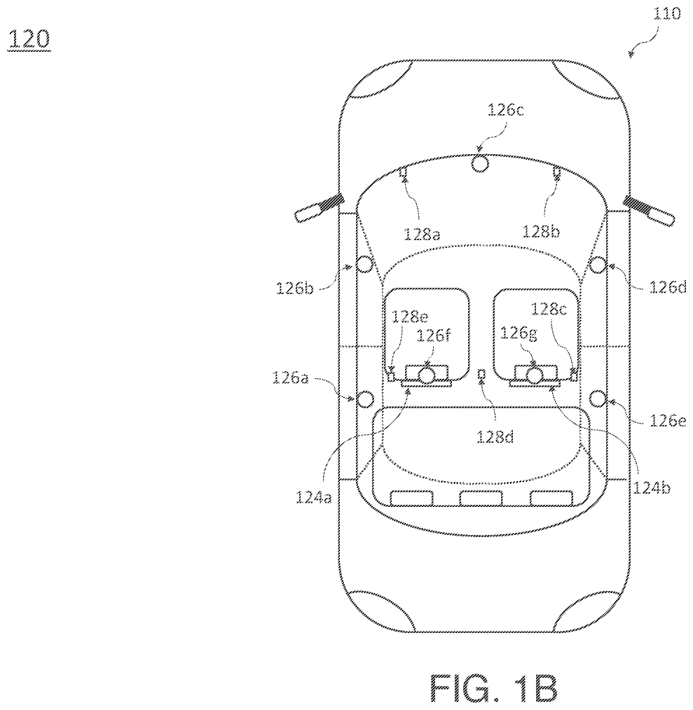

FIGS. 1A and 1B are diagrams 100, 120 illustrating an autonomous vehicle 110, according to some embodiments of the disclosure. The autonomous vehicle 110 includes a sensor suite 102 and an onboard computer 104. In various implementations, the autonomous vehicle 110 uses sensor information from the sensor suite 102 to determine its location, to navigate traffic, and to sense and avoid obstacles. According to various implementations, the autonomous vehicle 110 is part of a fleet of vehicles for picking up passengers and/or packages and driving to selected destinations. The autonomous vehicle 110 is configured to provide supervised stop.

The sensor suite 102 includes localization and driving sensors. For example, the sensor suite may include one or more of photodetectors, cameras, RADAR, SONAR, LIDAR, GPS, inertial measurement units (IMUs), accelerometers, microphones, strain gauges, pressure monitors, barometers, thermometers, altimeters, wheel speed sensors, and a computer vision system. The sensor suite 102 continuously monitors the autonomous vehicle's environment and, in some examples, sensor suite 102 data is used to detect selected events, and update a high fidelity map. In particular, data from the sensor suite can be used to update a map with information used to develop layers with waypoints identifying selected events, the locations of the encountered events, and the frequency with which the events are encountered at the identified location. In some examples, the presence and location of open parking spaces is detected and this information is recorded in a mapping system. In this way, sensor suite 102 data from many autonomous vehicles can continually provide feedback to the mapping system and the high fidelity map can be updated as more and more information is gathered.

In various examples, the sensor suite 102 includes cameras implemented using high-resolution imagers with fixed mounting and field of view. In further examples, the sensor suite 102 includes LIDARs implemented using scanning LIDARs. Scanning LIDARs have a dynamically configurable field of view that provides a point-cloud of the region intended to scan. In still further examples, the sensor suite 102 includes RADARs implemented using scanning RADARs with dynamically configurable field of view.

The autonomous vehicle 110 includes an onboard computer 104, which functions to control the autonomous vehicle 110. The onboard computer 104 processes sensed data from the sensor suite 102 and/or other sensors, in order to determine a state of the autonomous vehicle 110. In some implementations described herein, the autonomous vehicle 110 includes sensors inside the vehicle. In some examples, the autonomous vehicle 110 includes one or more cameras inside the vehicle. The cameras can be used to detect items or people inside the vehicle. In some examples, the autonomous vehicle 110 includes one or more weight sensors inside the vehicle, which can be used to detect items or people inside the vehicle. In some examples, the interior sensors can be used to detect passenger belongings left inside the vehicle. Based upon the vehicle state and programmed instructions, the onboard computer 104 controls and/or modifies driving behavior of the autonomous vehicle 110.

The onboard computer 104 functions to control the operations and functionality of the autonomous vehicle 110 and processes sensed data from the sensor suite 102 and/or other sensors in order to determine states of the autonomous vehicle. In some implementations, the onboard computer 104 is a general-purpose computer adapted for I/O communication with vehicle control systems and sensor systems. In some implementations, the onboard computer 104 is any suitable computing device. In some implementations, the onboard computer 104 is connected to the Internet via a wireless connection (e.g., via a cellular data connection). In some examples, the onboard computer 104 is coupled to any number of wireless or wired communication systems. In some examples, the onboard computer 104 is coupled to one or more communication systems via a mesh network of devices, such as a mesh network formed by autonomous vehicles. In some examples, the onboard computer 104 receives data from sensors inside the vehicle and uses sensor data to provide supervision of vehicle occupants.

According to various implementations, the autonomous driving system 100 of FIG. 1 functions to enable an autonomous vehicle 110 to modify and/or set a driving behavior in response to parameters set by vehicle passengers (e.g., via a passenger interface) and/or other interested parties (e.g., via a vehicle coordinator or a remote expert interface). Driving behavior of an autonomous vehicle may be modified according to explicit input or feedback (e.g., a passenger specifying a maximum speed or a relative comfort level), implicit input or feedback (e.g., a passenger's heart rate), or any other suitable data or manner of communicating driving behavior preferences. In some examples, a passenger requests that the autonomous vehicle 110 modify its route to add a selected supervised stop.

The autonomous vehicle 110 is preferably a fully autonomous automobile, but may additionally or alternatively be any semi-autonomous or fully autonomous vehicle. In various examples, the autonomous vehicle 110 is a boat, an unmanned aerial vehicle, a driverless car, a golf cart, a truck, a van, a recreational vehicle, a train, a tram, a three-wheeled vehicle, or a scooter. Additionally, or alternatively, the autonomous vehicles may be vehicles that switch between a semi-autonomous state and a fully autonomous state and thus, some autonomous vehicles may have attributes of both a semi-autonomous vehicle and a fully autonomous vehicle depending on the state of the vehicle.

In various implementations, the autonomous vehicle 110 includes a throttle interface that controls an engine throttle, motor speed (e.g., rotational speed of electric motor), or any other movement-enabling mechanism. In various implementations, the autonomous vehicle 110 includes a brake interface that controls brakes of the autonomous vehicle 110 and controls any other movement-retarding mechanism of the autonomous vehicle 110. In various implementations, the autonomous vehicle 110 includes a steering interface that controls steering of the autonomous vehicle 110. In one example, the steering interface changes the angle of wheels of the autonomous vehicle. The autonomous vehicle 110 may additionally or alternatively include interfaces for control of any other vehicle functions, for example, windshield wipers, headlights, turn indicators, air conditioning, etc.

FIG. 1B shows a cutaway top view of the autonomous vehicle 110, according to various embodiments of the disclosure. As shown in FIG. 1B, there are multiple cameras 126a, 126b, 126c, 126d, 126e, 126f, 126g located throughout the vehicle 110. According to various implementations, the autonomous vehicle 110 includes additional sensors 128a, 128b, 128c, 128d, 128e for monitoring occupants inside the vehicle. In some examples the sensors 128a-128e are microphones and can be used to monitor vehicle occupants and detect passenger feedback, passenger questions, and other passenger sounds. Similarly, the cameras 126a, 126b, 126c, 126d, 126e, 126f, 126g can be used to monitor vehicle occupants and detect passenger feedback and current passenger state. In some examples, the cameras 126a-126g and additional sensors 128a-128e can be used to record activity within the vehicle and transmit the data to the first passenger. In various implementations, the vehicle 110 can include any number of cameras 126a-126g and additional sensors 128a-128e, and the cameras 126a-126g and additional sensors 128a-128e can be located anywhere within the vehicle 110. In various examples, there are also one or more speakers inside the vehicle, which can be used to provide entertainment, voice assistance, and/or for communication (e.g., communication with the primary passenger or other phone calls).

In some implementations, the autonomous vehicle 110 includes screens in front of various passenger seats, such as the screens 124a, 124b in front of the rear passenger seats. In various examples, there are also screens in front of the front passenger seats and/or in front of the rear middle seat. In various examples, the screens 124a, 124b can be used to provide entertainment to supervised vehicle occupants during a supervised stop. The entertainment can include tv shows, movies, video games, photo reels, or any other visually presented content.

Example Method for Autonomous Vehicle Supervised Stops

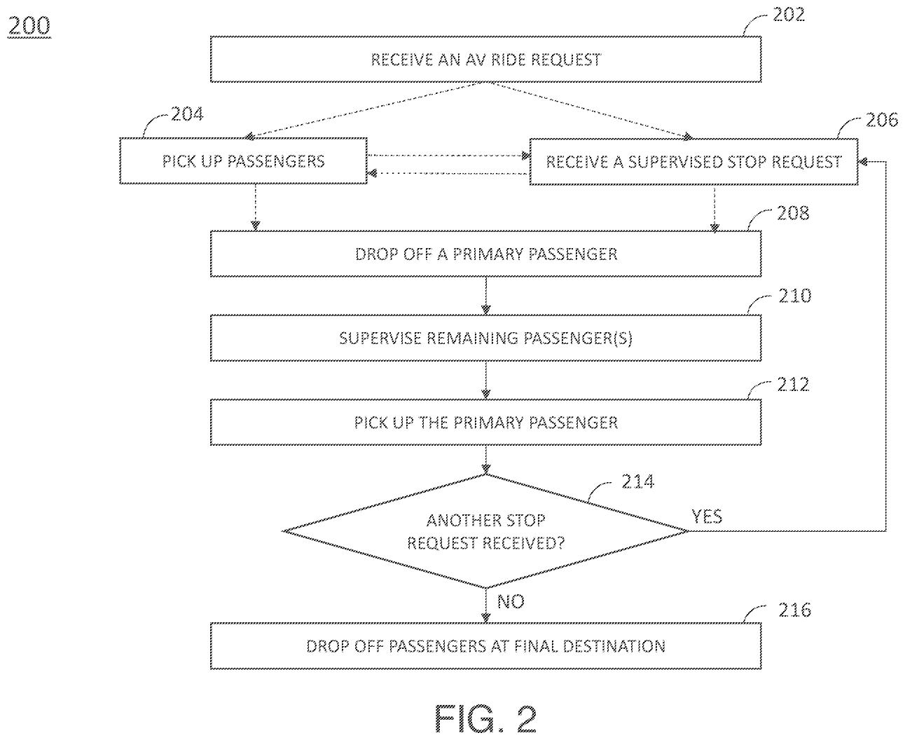

FIG. 2 is a diagram illustrating a method 200 for adding one or more supervised stops to an autonomous vehicle route, according to various embodiments of the invention. At step 202, an autonomous vehicle ride request is received. The ride request includes a pick up location and a destination location. In various examples, the ride request also includes a primary passenger (user) identification, as well as an indication of the number of passengers included in the ride request. In some examples, when additional passengers are included in the ride request, information about the passengers is collected, such as passenger age. In some examples, the primary passenger adds a pet to the ride, and in some examples, the primary passenger adds an additional passenger that is a pet.

At step 204, an autonomous vehicle picks up the passengers at the pick-up location. At step 206, a supervised stop request is received. In some examples, the supervised stop request is received (step 206) before the passengers are picked up (step 204). In some examples, the supervised stop request is received (step 206) after the passengers are picked up (step 204). In some examples, the supervised stop request is included with the ride request. The supervised stop request includes a stop location, a stop duration, and information about the passenger(s) to be supervised. In some examples, as step 206, an intermediate stop is requested, and, at the stop, the primary passenger enables a Supervised Mode.

At step 208, the primary passenger is dropped off at the stop location. In some examples, the primary passenger brings one or more other passengers along, while leaving one or more additional passengers in the autonomous vehicle. For example, the primary passenger may be a parent who brings along their toddler when exiting the vehicle, but leaves one or two older children inside the vehicle. In some examples, when the primary passenger exits the vehicle, the primary passenger enables a Supervised Mode and manually sends a command to lock the vehicle doors.

After dropping off the primary passenger, at step 210, the autonomous vehicle supervises the passenger or passengers remaining in the autonomous vehicle while waiting for the primary passenger to return. While supervising the passenger or passengers, the vehicle can enable entertainment features. The entertainment features enabled can depend on the number and type of passengers remaining in the vehicle (e.g., children, ages of children, pets, adults). Additionally, in some examples, while supervising the passenger or passengers, the vehicle enables additional safety features. While waiting for the primary passenger, the vehicle may park and/or circle the block, but generally the vehicle remains close to the stop location and close to the primary passenger.

According to various implementations, an autonomous vehicle in Supervised Mode can have different settings depending on the passenger or passengers remaining in the vehicle. In particular, the Supervised Mode can provide a customized experience for various passengers. In some examples, the Supervised Mode provides additional entertainment and comfort options for the remaining passenger(s), thereby extending the general in car experience. For instance, if the primary passenger is traveling with friends or other adults, entertainment and vehicle comfort may be the settings enabled during a supervised stop. In other examples, the Supervised Mode provides strong safety measures and communication channels for the remaining passenger(s), as discussed in further detail below. For instance, strong safety settings may be enabled when the remaining passengers are young children.

In various examples, supervising the remaining passenger or passengers at step 210 includes enabling one or more safety features. Safety features can include a livestream from the cabin (interior of the autonomous vehicle), a walkie-talkie system, tamper alerts, a reduced geofence, and remote HVAC (heating, ventilation, air conditioning) control. The cabin livestream includes streaming a live feed of the interior of the autonomous vehicle to the primary passenger's rideshare application. Using the cabin livestream feature, the primary passenger can monitor what is happening inside the vehicle cabin at any time. In some examples, the rideshare application can notify the primary passenger periodically with a snippet of the interior recording. For instance, if the noise level inside the cabin changes, the rideshare application can notify the primary passenger. Similarly, if the interior vehicle sensor system identifies a particular phrase such as “help”, “I'm hungry”, or “where's mom”, the rideshare application can notify the primary passenger. The primary passenger can use the livestream and notification information provided through the rideshare application to monitor the remaining passenger or passengers and potentially change plans based on the remaining passenger information.

In addition to a one-way cabin livestream, another safety feature available during the supervised stop is two-way communication. The two-way communication can include a walkie-talkie type system that allows the remaining passenger to talk to the primary passenger and allows the primary passenger to talk to the remaining passengers. Additionally, the two-way communication can include a two-way video stream, such that the primary passenger and remaining passenger can both talk to each other and see each other while they are physically apart. In some examples, the primary passenger can use ear phones to remain on the line with the remaining passenger and hear everything happening inside the vehicle. Using the two-way communication, the primary passenger can respond to the remaining passenger without interacting with the rideshare application. The two-way communication can be enabled for the duration of the supervised stop or for some portion of the supervised stop. In some implementations, the two-way communication can be set up with a tap-to-speak option for one or both parties, such that communication is only transmitted to the other party when the tap-to-speak option is selected.

Another safety feature available while the autonomous vehicle is supervising the remaining passenger or passengers is a reduced geofence. In particular, the distance the autonomous vehicle will travel from the primary passenger's location is reduced such that the vehicle remains close to the primary passenger. For example, the autonomous vehicle can circle the closest block to where the primary passenger is multiple times, rather than drive further away and return. While this may increase traffic density and could be less energy efficient than a longer drive, the reduced geofence can help minimize anxiety of the primary passenger and/or remaining passenger(s). In some examples, the primary passenger can adjust the geofence. In some examples, the primary passenger can choose to have the autonomous vehicle find an available parking space to park in during the supervised stop.

An additional safety feature available while the autonomous vehicle is supervising the remaining passenger or passengers is a tamper alert system. In particular, the tamper alert notifies the primary passenger if a remaining passenger tries to open the vehicle door from the inside and if someone attempts to enter the vehicle from the outside. In some examples, the tamper alerts are specialized urgent alerts. A Supervised Mode preset can enable child locks such that nobody can exit the vehicle without an override password or permission from the primary passenger's rideshare application, but the primary passenger is notified if someone is attempting to leave the vehicle. Furthermore, the primary passenger is notified if someone attempts to enter the vehicle. In some examples, if someone attempts to enter the vehicle, the vehicle engages a Safety Mode that includes one or more of loud external honking to deter the person attempting to enter, automatic connection to the primary passenger such that the primary passenger can see in livestream what is happening, the autonomous vehicle driving away from the person attempting to enter, and/or contacting authorities if the need to escalate the situation arises.

Another safety feature available while the autonomous vehicle is supervising the remaining passenger or passengers, and the autonomous vehicle is driving, is a seatbelt alert system. In particular, if the autonomous vehicle is not parked, the seatbelt alert system can be activated, such that if the remaining passenger or passengers unbuckles their seatbelt, the primary passenger is immediately notified. In some examples, if the remaining passenger or passengers unbuckles their seatbelt, the autonomous vehicle will pull over to the side of the road and park where possible. In some examples, if the remaining passenger or passengers unbuckles their seatbelt, the autonomous vehicle alerts the remaining passenger or passengers and asks that they buckle their seatbelt immediately.

Another safety feature available while the autonomous vehicle is supervising the remaining passenger or passengers is HVAC control. In particular, HVAC can be controlled remotely by the primary passenger as well as locally by the remaining passenger or passengers to ensure the right (and comfortable) settings. In some examples, a remaining passenger may complain “I'm hot” or “I'm cold”, and the interior vehicle sensor system detects and identifies the phrase. These statements can be transmitted to the primary passenger who can remotely adjust the HVAC settings. Additionally, in some examples, the autonomous vehicle can automatically adjust the HVAC settings in response to these statements, and alert the primary passenger to the change. In various examples, the HVAC safety feature can include additional alerts for air quality, carbon monoxide levels, and/or temperature warnings. The HVAC safety feature can be designed to ease the mind of the primary passenger by enabling monitoring of the interior vehicle air quality and temperature.

While the autonomous vehicle is supervising the remaining passenger or passengers, the autonomous vehicle can provide entertainment to the passenger or passengers. In various examples, the entertainment can be provided from the start of the ride, the entertainment can be initiated at any time during the ride, or the entertainment can be initiated at (or during) the supervised stop. In one example, if the remaining passenger or passengers include a young child, children's television can be turned on for clean entertainment. In some examples, specific shows and/or movies can be selected. In some examples, the autonomous vehicle is connected to one or more of the primary passenger's online entertainment streaming services (e.g., YouTube, Netflix, Spotify) and to a streaming service profile for a remaining passenger, where the remaining passenger can find shows they are currently watching or access their list. In some implementations, remaining passengers can access a rideshare gaming service and play a video game with each other locally (e.g., two siblings in the same autonomous vehicle). In some examples, remaining passenger or passengers can access the rideshare gaming service and play a video game live against other rideshare service passengers. In some implementations, the primary passenger and/or remaining passengers prefer the vehicle interior to remain calm, and a rest mode can be enabled to play soothing music, play a white noise, and/or cancel out street noise for an ultra-quiet cabin. Canceling out street noise can include emitting anti-phase sound waves thereby creating destructive interference with outside noises.

In general, while the autonomous vehicle is supervising the remaining passenger or passengers, one goal is to reduce anxiety of both parties regarding the remaining passengers being left in the vehicle away from the primary passenger. Any anxiety of the primary passenger is reduced by ensuring that the primary passenger has access to as much live information as possible, with live streams, communication channels, entertainment options, HVAC controls, and safety alerts, while also minimizing false alarms. Similarly, anxiety of the remaining vehicle occupants is reduced by ensuring the remaining vehicle occupants feel safe and connected to the primary passenger, providing the remaining vehicle occupants with control over their in-car experience, allowing the remaining vehicle occupants access to HVAC controls, and providing the remaining vehicle occupants with entertainment options.

In various examples, a voice assistant intermediary is used inside the autonomous vehicle to answer simple questions presented by the remaining passenger and reduce alerts to the primary passenger. The voice assistant intermediary can escalate and alert the primary passenger if necessary. For example, if the remaining passenger asks “when is mom coming back?”, the voice assistant intermediary can answer with the predicted time (e.g., “your mom should be back in 4 minutes.”). If one child begins crying, the voice assistant intermediary can ask “do you want me to call your mom?” and connect live using the two-way communication system if answered in the affirmative. In various examples, the voice assistant intermediary is an artificial intelligence system. In some implementations, the use of the voice assistant intermediary can be adjusted by the primary passenger in rideshare service Supervised Mode settings in the rideshare application. Similarly, the primary passenger can adjust notification/alert settings. For example, the primary passenger can turn on or off immediate notification of crying, yelling, certain words or phrases, changes in HVAC settings, etc.

Additionally, in some examples, a live remote assistant is available to monitor vehicle occupants during a supervised stop. In some examples, the remote assistant is alerted if there is a safety concern. In some examples, the remote assistant checks vehicle occupants at regular intervals. Regular checking and/or monitoring by the remote assistant may be enabled based on the age of the remaining passenger(s), such that younger passengers are regularly monitored while older children and teenagers are not. Regular checking and/or monitoring by the remote assistant can be a setting that the primary passenger can select. In some examples, the remote assistant is alerted if the primary passenger does not respond to an alert. In some examples, vehicle occupants can contact the remote assistant at any time.

In various implementations, a vehicle occupant can deactivate Supervised Mode. In one example, the vehicle occupant can enter a passcode to bypass the lock. For instance, if a vehicle occupant is an adult who wants to exit the vehicle without contacting the primary passenger, the vehicle occupant can enter a passcode. In some examples, the primary passenger is notified when a vehicle door is opened. In some examples, if an emergency occurs and remaining passengers need to exit the vehicle, a remote assistant can be immediately (and easily) contacted to unlock the doors.

In various implementations, the rideshare application Supervised Mode can be personalized and saved with different presets for different remaining passengers. That is, in some examples, the settings can be individually set for various remaining passengers (e.g., a parent can have different settings for each of several children). For example, a parent can have a first setting for their 4-year-old twins, a second setting for their 11-year-old, a third setting for their dog, and fourth setting for when their partner (or another adult) and one or more of the children are waiting together. In various examples, the settings can be automatically selected by the autonomous vehicle since the vehicle's interior sensors can detect the occupant number and type using, for example, image recognition.

In some implementations, the primary passenger can leave other passengers in the vehicle during an intermediate stop without enabling the Supervised Mode. For example, if one or more of the remaining passengers is an adult, the primary passenger may not enable in-vehicle supervision. When there are passengers waiting in the vehicle during an intermediate stop, the default in-vehicle experience is enabled, including entertainment options, but no additional safety features are automatically enabled.

At step 212, the autonomous vehicle picks up the primary passenger, and the Supervised Mode is disabled. In some examples, the autonomous vehicle picks up the primary passenger at the stop location. In other examples, the autonomous vehicle picks up the passenger at another location nearby the stop location. The autonomous vehicle picks up the primary passenger at the end of the stop duration. However, in some implementations, the duration of the stop can be modified by the primary passenger during the stop interval. In some examples, if the primary passenger modifies the stop duration, the remaining passenger or passengers are notified of the change by the in-vehicle voice assistant. For example, if the primary passenger completes the errand more quickly than expected, the primary passenger can request the stop duration be shortened and the autonomous vehicle return earlier than originally requested. In another example, if the primary passenger's errand takes longer than expected, the primary passenger can request extra time before pick-up. In some examples, the primary passenger can request a selected number of extra minutes before pick-up.

In some implementations, the stop duration is predicted based on the stop location. In one example, the stop duration prediction is based on the type of services and/or goods offered at the stop location. For example, a stop at a dry cleaner or a coffee shop may be predicted to be shorter than a stop at a grocery store. In some instances, the stop is a quick curb-side pick-up. In some examples, stop duration predictions are based on previous stops made by the same passenger at the same location. In some examples, stop duration predictions are based on previous stops made by other passengers at the same location. In some examples, stop duration predictions are based on previous stops made by the same passenger at similar locations. In some examples, stop duration predictions are based on previous stops made by other passengers at the similar location. Stop duration predictions may consider GPS location of the stop, including specific location of the passenger inside a store. Stop duration predictions may also consider the time of day, since certain times of day may be consistently (and predictably) busier than other times of day.

In some implementations, step 206 includes more than one supervised stop request, and the ride continues to another stop at step 208. In some implementations, more than one supervised stop is requested. After the passenger is picked up at step 212, if another supervised stop request is received, the method returns to step 208.

If there was not another supervised stop request, the method proceeds to step 216, and the passengers are dropped off at the final destination. In some examples, at the final destination, the passengers are given the option to end the ride or to have the autonomous vehicle wait.

In various implementations, the likelihood of a supervised stop request is predicted based on various factors. In one example, the trip history is considered in predicting supervised stop request likelihood. In another example, passengers allow the ride request application to access their calendar and/or notes, and the application detects tasks such as “pick up dry cleaning” or “buy vegetables”, and suggests the primary passenger add a supervised stop on the route when the primary passenger is accompanied by others.

Example Method for Autonomous Vehicle Supervised Stop Communication

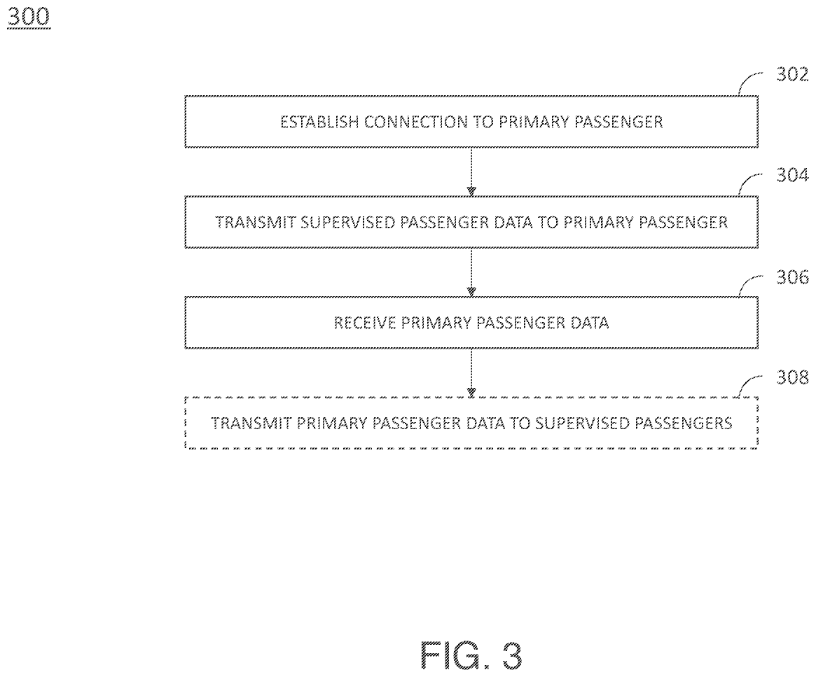

FIG. 3 is a diagram illustrating a method 300 for autonomous vehicle communication during a supervised stop, according to various embodiments of the invention. In particular, the method 300 occurs when a Supervised Mode is enabled at an intermediate stop. At step 302, the autonomous vehicle establishes a connection to the primary passenger. The connection includes a communication link between the autonomous vehicle and the primary passenger's mobile device. In some examples, the communication link interface is through a rideshare application on the primary parent's mobile device. In some examples, once the connection is established, the autonomous vehicle drops off the primary passenger at an intermediate stop, while one or more additional passengers remains in the autonomous vehicle. In other examples, the connection is established after the autonomous vehicle drops off the primary passenger.

At step 304, supervised passenger data is transmitted to the primary passenger via the primary passenger's mobile device. As discussed above, the data can include safety features such as a livestream from the cabin (interior of the autonomous vehicle), a two-way communication system, tamper alerts, a reduced geofence, autonomous vehicle location, and remote HVAC (heating, ventilation, air conditioning) control. The cabin livestream includes streaming a live feed of the interior of the autonomous vehicle including audio and video to the primary passenger's mobile device rideshare application. Using the cabin livestream feature, the primary passenger can monitor passengers inside the vehicle cabin. In some examples, the rideshare application can notify the primary passenger of any changes in the vehicle cabin. For instance, the rideshare application can notify the primary passenger if the noise level inside the cabin changes, if the interior vehicle sensor system identifies a particular phrase such as “help”, “I'm hungry”, or “where's mom”.

At step 306, the rideshare application receives data from the primary passenger. The data can include instructions for the autonomous vehicle, such as instructions to adjust the temperature inside the vehicle, updated information regarding the supervised stop duration, and instructions for the vehicle to return to pick up the primary passenger at a designated location. In general, the data can include any selections and/or input made through the rideshare application. Optionally, at step 308, data from the primary passenger is transmitted to vehicle occupants. Primary passenger data that may be transmitted to vehicle occupants can include any of the data received at step 306, and can also live audio and/or video data. Live audio and/or video data can be shared with the passengers remaining in the autonomous vehicle using in-vehicle speakers and/or screens. This enables two-way communication as discussed above with respect to FIG. 2, such that the primary passenger can communicate directly with the vehicle occupants.

Example Method for Autonomous Vehicle Supervised Stop Activity

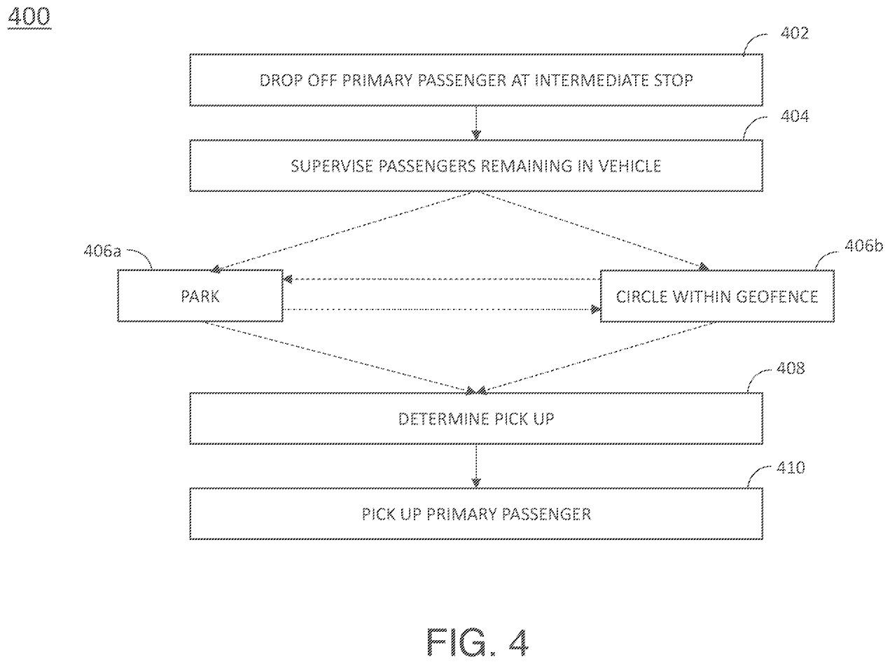

FIG. 4 is a diagram illustrating a method 400 for autonomous vehicle routing during a supervised stop, according to various embodiments of the invention. In particular, FIG. 4 illustrates different routing options for an autonomous vehicle during a supervised stop. At step 402, the autonomous vehicle drops off the primary passenger at an intermediate stop and enters a Supervise Mode. At step 404, the autonomous vehicle supervises the passenger or passengers remaining in the vehicle. According to various examples, the autonomous vehicle begins supervising remaining passengers before the primary passenger exits the vehicle at step 402.

After the primary passenger exits the vehicle, the autonomous vehicle proceeds to one or more of steps 406a and 406b. In some examples, at step 406a, the autonomous vehicle parks and waits for an indication that the primary passenger is ready to be picked up. In particular, the autonomous vehicle may use data from sensors in the sensor suite (such as sensor suite 102 of FIG. 1) to evaluate whether there are any nearby parking spaces and/or stopping spaces. This may include a space in a parking lot and/or street parking. The autonomous vehicle has access to information about whether parking in detected parking spaces is legal. This information may be included, for example, in autonomous vehicle maps. If the autonomous vehicle detects a parking space and/or stopping space, the autonomous vehicle may park in the space. In some examples, the autonomous vehicle receives information about a nearby parking space from a central computer and/or from another autonomous vehicle, and the autonomous vehicle drives to a parking space. In some examples, there are “hot spots” available for stopping in, where hot spots are common pick-up and drop-off areas for rideshare vehicles. In some examples, a fleet of autonomous vehicles may rent various parking spaces or a parking lot for use by vehicles in the fleet.

In some examples, at step 406b, the autonomous vehicle continues to drive. In various examples, if the autonomous vehicle continues to drive at step 406b, the vehicle remains within a geofenced area agreed upon by the primary passenger. In some examples, the autonomous vehicle circles a block, or drives within a small radius of the primary passenger drop off location. The autonomous vehicle may drive around within the geofenced area until it receives an indication that the primary passenger is ready to be picked up. In some instances, the autonomous vehicle continues driving because it does not find a parking spot nearby to park in. In some examples, the autonomous vehicle drives to a parking space located within the geofenced area to wait. In some examples, the autonomous vehicle detects an open parking space while driving around and parks in the detected parking space to wait. In various implementations, the autonomous vehicle may perform either or both of steps 406a and 406b while waiting to pick up the primary passenger. According to some implementations, continuously updated autonomous vehicle location information is shared with the primary passenger through the rideshare application on the primary passenger's mobile device, such that the primary passenger is able to determine exactly where the remaining passengers are at any given moment.

In various implementations, the primary passenger pays an extra fee for supervised stops. In particular, the primary passenger pays for additional use of the autonomous vehicle, since the primary passenger has exclusive use of the vehicle during the supervised stop. The fee may change depending on the duration of the stop and whether the vehicle is parked or driving during the stop. In some examples, during the supervised stop, the primary passenger can add extra time to the stop duration for an extra fee. In some examples, the autonomous vehicle may charge its battery during a supervised stop if there is a parking space with a charging station available close to the stop location.

At step 408, the autonomous vehicle determines a pick-up time and location for the primary passenger. During the supervised stop, the pick-up time may change for various reasons. For example, the primary passenger can adjust the pick-up time. The primary passenger may be running late or the primary passenger may be early. At step 408, the pick-up time is confirmed. In some examples, the primary passenger is prompted with reminders as the pick-up time approaches and asked to confirm the pick-up time.

Additionally, in some examples, at step 408, the pick-up location is determined. In various examples, the pick-up location may differ slightly from the drop off location. For example, the pick-up location may be around the corner, or in a parking space a half a block away. Adjusting the pick-up location can allow for faster pick up of the primary passenger, especially in high traffic areas. In some examples, the primary passenger can request that the pick-up location be within a selected walking distance of the drop off location. In some examples, the primary passenger can request the pick-up location be the same as the drop off location. For instance, if the primary passenger is mobility-impaired, the primary passenger may prefer to wait than to walk a short distance to the autonomous vehicle. At step 410, the primary passenger is picked up from the intermediate stop.

Example of a Supervised Stop Request Interface

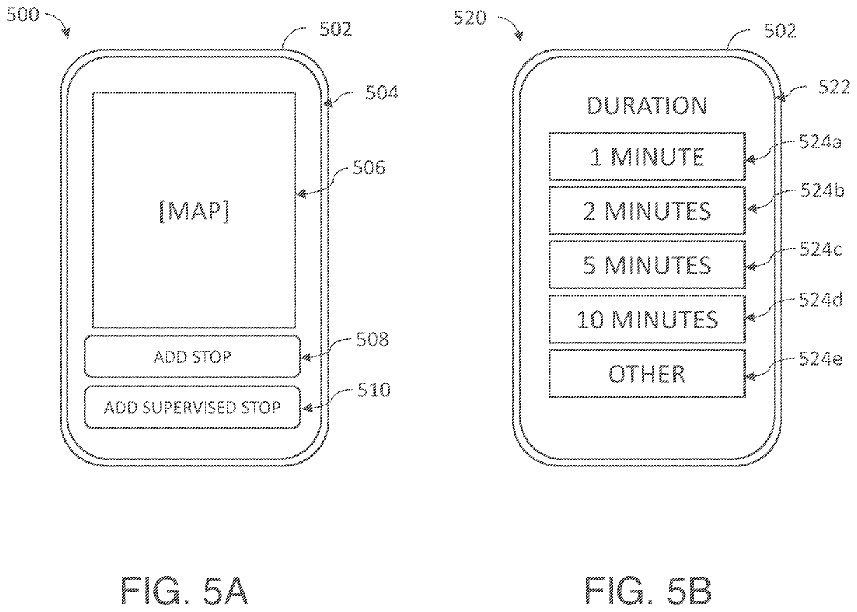

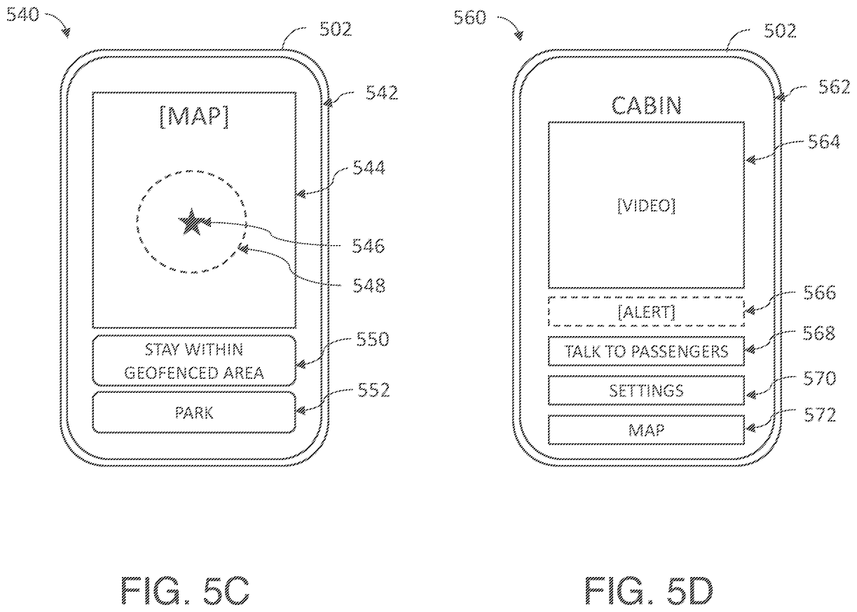

FIGS. 5A-5D show examples 500, 520, 540, 560 of an interface for requesting supervised stops, according to some embodiments of the disclosure. FIG. 5A shows an example 500 of a device 502 showing an interface 504 having a map 506, an “add stop” button 508, and an “add supervised stop” button 510. In various examples, the map 506 shows a user's location and/or a selected destination location. In some examples, the map shows a route between the user's location and a destination location. In various implementations, the map shows one or more suggested stops. The suggested stops may be stops the user has previously requested, stops similar to stops the user has previously requested, stops other users have requested, and/or sponsored stop suggestions. In some implementations, the map does not show suggested stops.

The interface 504 includes an “add a stop” button 508 for the user to add an intermediate stop to a route. Selecting the “add a stop” button 508 allows the user to select an intermediate stop location by selecting a suggested stop, searching for a stop by name, and/or adding an address of a stop. The stop is added to the user's route.

The interface 504 includes an “add a supervised stop” button 510 for the user when multiple riders are included in the ride. In addition to adding a stop to the user's route, the supervised stop option includes the features discussed herein for supervising vehicle occupants via the rideshare application during the stop. In some examples, a user has already set up supervised stop settings for one or more additional passengers, and the settings are automatically applied when the user selects the “add a supervised stop” button 510. In some examples, the user is given the option to choose a pre-set supervised stop setting, with suggestions based on the age of the remaining passenger and/or type of the remaining passenger (e.g., the remaining passenger may be a pet).

After adding a stop, the user is optionally prompted to indicate the duration of the selected stop. FIG. 5B shows an example 520 of the device 502 showing an interface 522 having duration selections. In the example shown in FIG. 5B, the user can select a stop duration of “1 minute” 524a, “2 minutes” 524b, “5 minutes” 524c, “10 minutes” 524c, or “other” 524e. In some examples, if the user selects “other” 524e, the user is then prompted to set the stop duration. In other examples, if the user selects “other” 524e, the user is prompted to enter a stop duration. In various implementations, the specific durations of the duration selections 524a-524e depends on the type of store at the stop destination. In some examples, the specific durations are based on stop duration predictions based on stops at the selected location made by the same and/or other users. As discussed above, during the stopping interval, the user may be prompted to update and/or confirm the pick-up time.

After adding a supervised stop, the user is prompted to adjust a geofenced area for the autonomous vehicle during the stop, and can also request that the autonomous vehicle park during the stop. FIG. 5C shows an example 540 of the device 502 showing an interface 542 having a map 544 showing the stop location 546 and a geofenced area 548 around the stop location 546. In various examples, the geofenced area 548 can be any selected shape and, in some examples, can follow selected streets around the stop location 546. The user can request that the vehicle remain within the geofenced area 548 by selecting the button 550. Alternatively, the user can request that the vehicle park during the stop by selecting the button 552. In some examples, a parking space is not available, and the park button 552 is grayed out. In some examples, a parking space is available for an additional fee (e.g., a parking lot, and/or metered parking), and the user may be given the option to agree to pay for the parking spot after selecting the park button 552, or the user is given the option to choose to allow the vehicle to continue driving within the geofenced area 548.

Once Supervised Mode has begun and the user (who is also the primary passenger) exits the vehicle, the rideshare application can display to the user the interior of the cabin, including the remaining passengers. FIG. 5D shows an example 560 of the device 502 showing an interface 562 having a video display 564, an alert notification 566, as well as an option to talk to the passengers by selecting the button 568, an option to adjust vehicle settings by selecting the button 570, and/or an option to show vehicle location on the map by selecting the button 572. In some examples, the video display 564 shows a livestream of video inside the cabin, including a view of any remaining passengers. The alert notification 566 only appears if the autonomous vehicle sends an alert to the user. In some examples, the alert will make sound and/or flash until it is acknowledged. In some examples, if the user is not actively engaging with rideshare application on the mobile device, the alert will appear over/on top of any other open application and make sound and/or flash. If the user is not actively engaging with the mobile device at all, the alert will appear on a lock screen and make a sound and/or flash until it is acknowledged.

The interface 562 also includes several buttons. When a user selects a “talk to passengers” button 568, a two-way connection with the vehicle cabin interior is established, and the user can talk with the remaining passengers. The two-way connection can also include video such that the user appears on an in-vehicle screen while remaining passengers appear in the video display 564. When a user selects the “settings” button, the user can adjust vehicle settings as well as Supervised Modes settings. For example, the user can adjust vehicle temperature and/or vehicle entertainment options. When a user selects the “map” button, the interface 562 displays a map showing the vehicle location. In some examples, the map shows both the vehicle location and the user location. In various examples, the user can zoom in or out on the map.

Example of Autonomous Vehicle Fleet

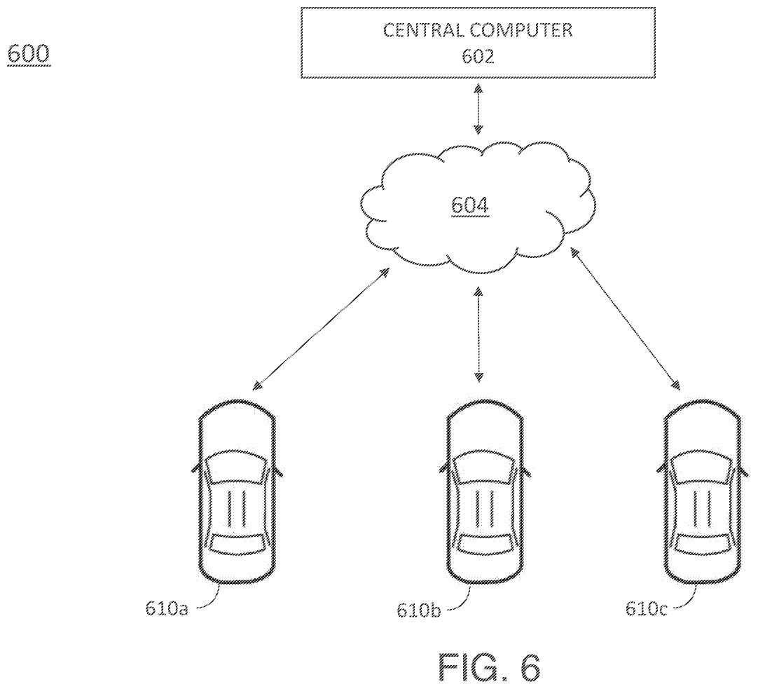

FIG. 6 is a diagram illustrating a fleet of autonomous vehicles 610a-610c in communication with a central computer 602, according to some embodiments of the disclosure. As shown in FIG. 6, the vehicles 610a-610c communicate wirelessly with a cloud 604 and a central computer 602. The central computer 602 includes a routing coordinator and a database of information from the vehicles 610a-610c in the fleet. Autonomous vehicle fleet routing refers to the routing of multiple vehicles in a fleet. In some implementations, autonomous vehicles communicate directly with each other.

When a ride request is received from a passenger, the routing coordinator selects an autonomous vehicle 610a-610c to fulfill the ride request, and generates a route for the autonomous vehicle 610a-610c. The generated route includes a route from the autonomous vehicle's present location to the pick-up location, and a route from the pick-up location to the final destination. In some examples, the ride request includes a supervised stop request and the generated route includes a route to the stop location. The generated route also includes instructions for autonomous vehicle behavior during the stopping interval. In various examples, the generated route includes instructions for a parking location during the supervised stopping interval and/or the generated route includes a route within a geofenced area for driving around during the stopping interval. Autonomous vehicle behavior during the supervised stopping interval may depend on the stop duration as described above with respect to FIG. 4.

The generated route can be updated while the vehicle is on the route. In some examples, a supervised stop request is received after a passenger has been picked up. The generated route is updated to include the supervised stop, as well as to include autonomous vehicle routing instructions during the stop.

Each vehicle 610a-610c in the fleet of vehicles communicates with a routing coordinator. Information gathered by various autonomous vehicles 610a-610c in the fleet can be saved and used to generate information for future routing determinations. For example, sensor data can be used to generate route determination parameters. In general, the information collected from the vehicles in the fleet can be used for route generation or to modify existing routes. In some examples, the routing coordinator collects and processes position data from multiple autonomous vehicles in real-time to avoid traffic and generate a fastest-time route for each autonomous vehicle. In some implementations, the routing coordinator uses collected position data to generate a best route for an autonomous vehicle in view of one or more travelling preferences and/or routing goals.

In various examples, the data collected by the routing coordinator is used to determine autonomous vehicle routing during a stopping interval. Additionally, data collected by the routing coordinator is used to determine autonomous vehicle fleet efficiency when allowing a user to reserve the autonomous vehicle for exclusive use during a stopping interval. In some examples, the fee charged for exclusive use of an autonomous vehicle during a stopping interval is correlated with fleet efficiency. In particular, pricing can be adjusted dynamically to encourage passengers to select the more efficient option. For example, the greater the negative impact of exclusive use of a specific autonomous vehicle on overall fleet efficiency, the higher the cost of the exclusive use option. Thus, in some examples, the exclusive use option is more expensive during a busy time period and less expensive during a slow time period.

According to various implementations, a set of parameters can be established that determine which metrics are considered (and to what extent) in determining routes or route modifications. In some examples, the route includes autonomous vehicle routing during a supervised stopping interval, as described in greater detail with respect to FIG. 4. Generally, a routing goal refers to, but is not limited to, one or more desired attributes of a routing plan indicated by at least one of an administrator of a routing server and a user of the autonomous vehicle. The desired attributes may relate to a desired duration of a route plan, a comfort level of the route plan, a vehicle type for a route plan, and the like. For example, a routing goal may include time of an individual trip for an individual autonomous vehicle to be minimized, subject to other constraints. As another example, a routing goal may be that comfort of an individual trip for an autonomous vehicle be enhanced or maximized, subject to other constraints. In another example, a routing goal includes on time pick up of a passenger at the end of a supervised stop.

Routing goads may be specific or general in terms of both the vehicles they are applied to and over what timeframe they are applied. As an example of routing goal specificity in vehicles, a routing goal may apply only to a specific vehicle, or to all vehicles in a specific region, or to all vehicles of a specific type, etc. Routing goal timeframe may affect both when the goal is applied (e.g., some goals may be ‘active’ only during set times) and how the goal is evaluated (e.g., for a longer-term goal, it may be acceptable to make some decisions that do not optimize for the goal in the short term, but may aid the goal in the long term). Likewise, routing vehicle specificity may also affect how the goal is evaluated; e.g., decisions not optimizing for a goal may be acceptable for some vehicles if the decisions aid optimization of the goal across an entire fleet of vehicles.

Some examples of routing goals include goals involving trip duration (either per trip, or average trip duration across some set of vehicles and/or times), physics, laws, and/or company policies (e.g., adjusting routes chosen by users that end in lakes or the middle of intersections, refusing to take routes on highways, etc.), distance, velocity (e.g., max., min., average), source/destination (e.g., it may be optimal for vehicles to start/end up in a certain place such as in a pre-approved parking space or charging station), intended arrival time (e.g., when a user wants to arrive at a destination), duty cycle (e.g., how often a car is on an active trip vs. idle), energy consumption (e.g., gasoline or electrical energy), maintenance cost (e.g., estimated wear and tear), money earned (e.g., for vehicles used for ridesharing), person-distance (e.g., the number of people moved multiplied by the distance moved), occupancy percentage, higher confidence of arrival time, user-defined routes or waypoints, fuel status (e.g., how charged a battery is, how much gas is in the tank), passenger satisfaction (e.g., meeting goals set by or set for a passenger) or comfort goals, environmental impact, passenger safety, pedestrian safety, toll cost, etc. In examples where vehicle demand is important, routing goals may include attempting to address or meet vehicle demand.

Routing goals may be combined in any manner to form composite routing goals; for example, a composite routing goal may attempt to optimize a performance metric that takes as input trip duration, rideshare revenue, and energy usage and also, optimize a comfort metric. The components or inputs of a composite routing goal may be weighted differently and based on one or more routing coordinator directives and/or passenger preferences.

Likewise, routing goals may be prioritized or weighted in any manner. For example, a set of routing goals may be prioritized in one environment, while another set may be prioritized in a second environment. As a second example, a set of routing goals may be prioritized until the set reaches threshold values, after which point a second set of routing goals take priority. Routing goals and routing goal priorities may be set by any suitable source (e.g., an autonomous vehicle routing platform, an autonomous vehicle passenger).

The routing coordinator uses maps to select an autonomous vehicle from the fleet to fulfill a ride request. In some implementations, the routing coordinator sends the selected autonomous vehicle the ride request details, including pick-up location and destination location, and an onboard computer on the selected autonomous vehicle generates a route and navigates to the destination and/or any supervised stop. Similarly, in some examples, during a supervised stop, the onboard computer determines whether the autonomous vehicle parks or continues to drive and circles back to the pick-up location. In some implementations, the routing coordinator in the central computing system 602 generates a route for each selected autonomous vehicle 610a-610c, and the routing coordinator determines a route for the autonomous vehicle 610a-610c to travel from the autonomous vehicle's current location to a first intermediate stop.

Example of a Computing System for Ride Requests

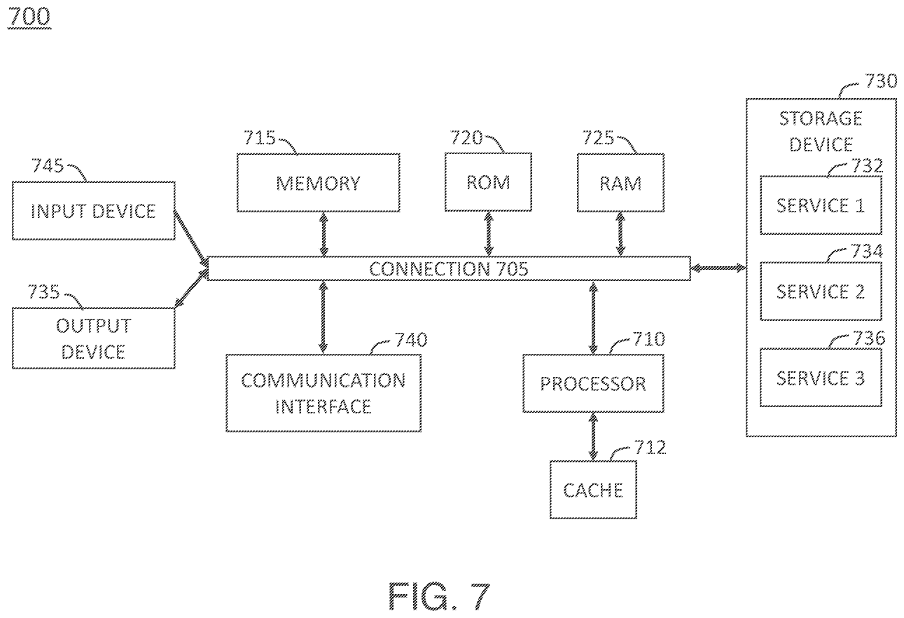

FIG. 7 shows an example embodiment of a computing system 700 for implementing certain aspects of the present technology. In various examples, the computing system 700 can be any computing device making up the onboard computer 104, the central computing system 602, or any other computing system described herein. The computing system 700 can include any component of a computing system described herein which the components of the system are in communication with each other using connection 705. The connection 705 can be a physical connection via a bus, or a direct connection into processor 710, such as in a chipset architecture. The connection 705 can also be a virtual connection, networked connection, or logical connection.

In some implementations, the computing system 700 is a distributed system in which the functions described in this disclosure can be distributed within a datacenter, multiple data centers, a peer network, etc. In some embodiments, one or more of the described system components represents many such components each performing some or all of the functions for which the component is described. In some embodiments, the components can be physical or virtual devices.

The example system 700 includes at least one processing unit (CPU or processor) 710 and a connection 705 that couples various system components including system memory 715, such as read-only memory (ROM) 720 and random access memory (RAM) 725 to processor 710. The computing system 700 can include a cache of high-speed memory 712 connected directly with, in close proximity to, or integrated as part of the processor 710.

The processor 710 can include any general-purpose processor and a hardware service or software service, such as services 732, 734, and 736 stored in storage device 730, configured to control the processor 710 as well as a special-purpose processor where software instructions are incorporated into the actual processor design. The processor 710 may essentially be a completely self-contained computing system, containing multiple cores or processors, a bus, memory controller, cache, etc. A multi-core processor may be symmetric or asymmetric.

To enable user interaction, the computing system 700 includes an input device 745, which can represent any number of input mechanisms, such as a microphone for speech, a touch-sensitive screen for gesture or graphical input, keyboard, mouse, motion input, speech, etc. The computing system 700 can also include an output device 735, which can be one or more of a number of output mechanisms known to those of skill in the art. In some instances, multimodal systems can enable a user to provide multiple types of input/output to communicate with the computing system 700. The computing system 700 can include a communications interface 740, which can generally govern and manage the user input and system output. There is no restriction on operating on any particular hardware arrangement, and therefore the basic features here may easily be substituted for improved hardware or firmware arrangements as they are developed.

A storage device 730 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 730 can include software services, servers, services, etc., that when the code that defines such software is executed by the processor 710, it causes the system to perform a function. In some embodiments, a hardware service that performs a particular function can include the software component stored in a computer-readable medium in connection with the necessary hardware components, such as a processor 710, a connection 705, an output device 735, etc., to carry out the function.

As discussed above, each vehicle in a fleet of vehicles communicates with a routing coordinator. When a vehicle is flagged for service, the routing coordinator schedules the vehicle for service and routes the vehicle to the service center. When the vehicle is flagged for maintenance, a level of importance or immediacy of the service can be included. As such, service with a low level of immediacy will be scheduled at a convenient time for the vehicle and for the fleet of vehicles to minimize vehicle downtime and to minimize the number of vehicles removed from service at any given time. In some examples, the service is performed as part of a regularly-scheduled service. Service with a high level of immediacy may require removing vehicles from service despite an active need for the vehicles.

Routing goals may be specific or general in terms of both the vehicles they are applied to and over what timeframe they are applied. As an example of routing goal specificity in vehicles, a routing goal may apply only to a specific vehicle, or to all vehicles of a specific type, etc. Routing goal timeframe may affect both when the goal is applied (e.g., urgency of the goal, or, some goals may be ‘active’ only during set times) and how the goal is evaluated (e.g., for a longer-term goal, it may be acceptable to make some decisions that do not optimize for the goal in the short term, but may aid the goal in the long term). Likewise, routing vehicle specificity may also affect how the goal is evaluated; e.g., decisions not optimizing for a goal may be acceptable for some vehicles if the decisions aid optimization of the goal across an entire fleet of vehicles.

In various implementations, the routing coordinator is a remote server or a distributed computing system connected to the autonomous vehicles via an internet connection. In some implementations, the routing coordinator is any suitable computing system. In some examples, the routing coordinator is a collection of autonomous vehicle computers working as a distributed system.

As described herein, one aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

### Select Examples

Example 1 provides a method for adding supervised stops to an autonomous vehicle route, comprising receiving a ride request including a pick-up location and a destination location; picking up a plurality of passengers at the pick-up location, wherein the plurality of passengers include a primary passenger and a secondary passenger; receiving a supervised stop request including a stop location; dropping off a primary passenger at the stop location for a selected stop duration; and supervising a secondary passenger during the stop duration, wherein supervising the secondary passenger includes detecting a secondary passenger event and responding to the secondary passenger event.

Example 2 provides a method according to one or more of the preceding and/or following examples, wherein responding to the secondary passenger event includes at least one of triggering an automated response and notifying the primary passenger.

Example 3 provides a method according to one or more of the preceding and/or following examples, wherein triggering an automated response includes responding using a voice assistant intermediary.

Example 4 provides a method according to one or more of the preceding and/or following examples, wherein detecting a secondary passenger event includes passively detecting the secondary passenger event using in-cabin sensors.

Example 5 provides a method according to one or more of the preceding and/or following examples, wherein detecting a secondary passenger event includes at least one of detecting a selected word, detecting a selected phrase, and detecting noise exceeding a selected sound level threshold.

Example 6 provides a method according to one or more of the preceding and/or following examples, further comprising receiving secondary passenger information and second passenger supervision settings in a primary passenger rideshare account profile.

Example 7 provides a method according to one or more of the preceding and/or following examples, further comprising identifying the secondary passenger.

Example 8 provides a method according to one or more of the preceding and/or following examples, wherein supervising the secondary passenger further includes enabling a safety feature, wherein the safety feature is activated on a primary passenger rideshare account, and wherein the safety feature includes at least one of an external door tamper alert, an internal door tamper alert, an unbuckled seatbelt alert, and an air quality alert.

Example 9 provides a method according to one or more of the preceding and/or following examples, further comprising establishing a communication link between an interior cabin of the autonomous vehicle and a primary passenger rideshare application.

Example 10 provides a method according to one or more of the preceding and/or following examples, further comprising defining a geofenced area for the autonomous vehicle during the stop duration.

Example 11 provides a method according to one or more of the preceding and/or following examples, further comprising establishing a connection with a passenger rideshare account and transmitting vehicle information to the passenger rideshare account.

Example 12 provides a system for addition of a supervised stop to an autonomous vehicle route, comprising: a central computing system including a routing coordinator configured to: receive a ride request including a pick-up location and a destination location, and select an autonomous vehicle to fulfill the ride request; a plurality of sensors in a cabin of the autonomous vehicle; and an onboard computing system on the autonomous vehicle configured to: direct the autonomous vehicle to the pick-up location for pick up of a plurality of passengers, wherein the plurality of passengers include a primary passenger and a secondary passenger; receive a supervised stop request, wherein the supervised stop request includes a stop location and a stop duration; direct the autonomous vehicle to drop off the primary passenger at the stop location; and supervise the secondary passenger during the stop duration, wherein supervising the secondary passenger includes: detecting, based on data from the plurality of sensors, a secondary passenger event, and responding to the secondary passenger event.

Example 13 provides a system according to one or more of the preceding and/or following examples, wherein the central computing system is further configured to receive the supervised stop request, and send the supervised stop request to the autonomous vehicle.

Example 14 provides a system according to one or more of the preceding and/or following examples, wherein the plurality of sensors are passive sensors and wherein the onboard computing system is configured to use the data from the plurality of sensors to detect the secondary passenger event by detecting at least one of a selected word, a selected phrase, and noise exceeding a selected sound level threshold.

Example 15 provides a system according to one or more of the preceding and/or following examples, wherein the onboard computing system is further configured to respond to the secondary passenger event by at least one of notifying the primary passenger and using a voice assistant intermediary to respond to the second passenger.

Example 16 provides a system according to one or more of the preceding and/or following examples, wherein the central computing system includes a database having primary passenger rideshare account information, and wherein the primary passenger rideshare account information includes secondary passenger profile information and supervision settings for supervised stops.

Example 17 provides a system according to one or more of the preceding and/or following examples, wherein the onboard computing system is further configured to identify the second passenger based on image data from the plurality of sensors and based on the secondary passenger profile information.

Example 18 provides an autonomous vehicle for providing supervision during an intermediate stop, comprising: a plurality of sensors positioned within in an interior cabin; a screen configured to display video; an onboard computing system configured to: receive ride request information including a pick-up location and a destination location; direct the autonomous vehicle to the pick-up location for pick up of a plurality of passengers, wherein the plurality of passengers include a primary passenger and a secondary passenger; receive a request for a supervised stop through a primary passenger rideshare account, wherein the supervised stop request includes a stop location and a stop duration; direct the autonomous vehicle to drop off the primary passenger at the stop location; and supervise the secondary passenger during the supervised stop, wherein supervising the secondary passenger includes: detecting, based on data from the plurality of sensors, a secondary passenger event, and responding to the secondary passenger event.

Example 19 provides an autonomous vehicle according to one or more of the preceding and/or following examples, wherein the plurality of sensors are passive sensors and wherein the onboard computing system is configured to use the data from the plurality of sensors to detect the secondary passenger event by detecting at least one of a selected word, a selected phrase, and noise exceeding a selected sound level threshold.

Example 20 provides an autonomous vehicle according to one or more of the preceding and/or following examples, wherein the screen is configured to provide communication between a primary passenger rideshare account and a secondary passenger during the supervised stop.

Example 21 provides an autonomous vehicle according to one or more of the preceding and/or following examples, wherein the screen is configured to provide entertainment to the secondary passenger during the supervised stop, wherein entertainment options are based on supervised stop settings in the primary passenger rideshare account.

Example 22 provides a method according to one or more of the preceding and/or following examples, further comprising live remote monitoring of the secondary passenger.

Example 23 provides a method according to one or more of the preceding and/or following examples, further comprising providing live remote assistance to the secondary passenger.

### VARIATIONS AND IMPLEMENTATIONS

According to various examples, driving behavior includes any information relating to how an autonomous vehicle drives. For example, driving behavior includes how and when the autonomous vehicle actuates its brakes and its accelerator, and how it steers. In particular, the autonomous vehicle is given a set of instructions (e.g., a route or plan), and the driving behavior determines how the set of instructions is implemented to drive the car to and from various destinations, and, potentially, to stop for passengers or items. Driving behavior may include a description of a controlled operation and movement of an autonomous vehicle and the manner in which the autonomous vehicle applies traffic rules during one or more driving sessions. Driving behavior may additionally or alternatively include any information about how an autonomous vehicle calculates routes (e.g., prioritizing fastest time vs. shortest distance), other autonomous vehicle actuation behavior (e.g., actuation of lights, windshield wipers, traction control settings, etc.) and/or how an autonomous vehicle responds to environmental stimulus (e.g., how an autonomous vehicle behaves if it is raining, or if an animal jumps in front of the vehicle). Some examples of elements that may contribute to driving behavior include acceleration constraints, deceleration constraints, speed constraints, steering constraints, suspension settings, routing preferences (e.g., scenic routes, faster routes, no highways), lighting preferences, “legal ambiguity” conduct (e.g., in a solid-green left turn situation, whether a vehicle pulls out into the intersection or waits at the intersection line), action profiles (e.g., how a vehicle turns, changes lanes, or performs a driving maneuver), and action frequency constraints (e.g., how often a vehicle changes lanes). Additionally, driving behavior includes information relating to whether the autonomous vehicle drives and/or parks.

As will be appreciated by one skilled in the art, aspects of the present disclosure, in particular aspects of a perception system for an autonomous vehicle, described herein, may be embodied in various manners (e.g., as a method, a system, a computer program product, or a computer-readable storage medium). Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Functions described in this disclosure may be implemented as an algorithm executed by one or more hardware processing units, e.g. one or more microprocessors, of one or more computers. In various embodiments, different steps and portions of the steps of each of the methods described herein may be performed by different processing units. Furthermore, aspects of the present disclosure may take the form of a computer program product embodied in one or more computer readable medium(s), preferably non-transitory, having computer readable program code embodied, e.g., stored, thereon. In various embodiments, such a computer program may, for example, be downloaded (updated) to the existing devices and systems (e.g. to the existing perception system devices and/or their controllers, etc.) or be stored upon manufacturing of these devices and systems.

The following detailed description presents various descriptions of specific certain embodiments. However, the innovations described herein can be embodied in a multitude of different ways, for example, as defined and covered by the claims and/or select examples. In the following description, reference is made to the drawings where like reference numerals can indicate identical or functionally similar elements. It will be understood that elements illustrated in the drawings are not necessarily drawn to scale. Moreover, it will be understood that certain embodiments can include more elements than illustrated in a drawing and/or a subset of the elements illustrated in a drawing. Further, some embodiments can incorporate any suitable combination of features from two or more drawings.

The preceding disclosure describes various illustrative embodiments and examples for implementing the features and functionality of the present disclosure. While particular components, arrangements, and/or features are described below in connection with various example embodiments, these are merely examples used to simplify the present disclosure and are not intended to be limiting. It will of course be appreciated that in the development of any actual embodiment, numerous implementation-specific decisions must be made to achieve the developer's specific goals, including compliance with system, business, and/or legal constraints, which may vary from one implementation to another. Moreover, it will be appreciated that, while such a development effort might be complex and time-consuming; it would nevertheless be a routine undertaking for those of ordinary skill in the art having the benefit of this disclosure.

In the Specification, reference may be made to the spatial relationships between various components and to the spatial orientation of various aspects of components as depicted in the attached drawings. However, as will be recognized by those skilled in the art after a complete reading of the present disclosure, the devices, components, members, apparatuses, etc. described herein may be positioned in any desired orientation. Thus, the use of terms such as “above”, “below”, “upper”, “lower”, “top”, “bottom”, or other similar terms to describe a spatial relationship between various components or to describe the spatial orientation of aspects of such components, should be understood to describe a relative relationship between the components or a spatial orientation of aspects of such components, respectively, as the components described herein may be oriented in any desired direction. When used to describe a range of dimensions or other characteristics (e.g., time, pressure, temperature, length, width, etc.) of an element, operations, and/or conditions, the phrase “between X and Y” represents a range that includes X and Y.

Other features and advantages of the disclosure will be apparent from the description and the claims. Note that all optional features of the apparatus described above may also be implemented with respect to the method or process described herein and specifics in the examples may be used anywhere in one or more embodiments.

The ‘means for’ in these instances (above) can include (but is not limited to) using any suitable component discussed herein, along with any suitable software, circuitry, hub, computer code, logic, algorithms, hardware, controller, interface, link, bus, communication pathway, etc. In a second example, the system includes memory that further comprises machine-readable instructions that when executed cause the system to perform any of the activities discussed above.

What is claimed is:

1. A method for adding supervised stops to an autonomous vehicle route, comprising:
receiving a ride request including a pick-up location and a destination location;
picking up a plurality of passengers at the pick-up location, wherein the plurality of passengers include a primary passenger and a secondary passenger;
receiving a supervised stop request including a stop location;
dropping off a primary passenger at the stop location for a stop duration; and
supervising a secondary passenger during the stop duration, wherein supervising the secondary passenger includes detecting a secondary passenger event and responding to the secondary passenger event.

2. The method of claim 1, wherein responding to the secondary passenger event includes at least one of triggering an automated response and notifying the primary passenger.

3. The method of claim 2, wherein triggering an automated response includes responding using a voice assistant intermediary.

4. The method of claim 1, wherein detecting a secondary passenger event includes passively detecting the secondary passenger event using in-cabin sensors.

5. The method of claim 1, wherein detecting a secondary passenger event includes at least one of detecting a selected word, detecting a selected phrase, and detecting noise exceeding a selected sound level threshold.

6. The method of claim 1, further comprising receiving secondary passenger information and second passenger supervision settings in a primary passenger rideshare account profile.

7. The method of claim 1, further comprising identifying the secondary passenger.

8. The method of claim 1, wherein supervising the secondary passenger further includes enabling a safety feature, wherein the safety feature is activated on a primary passenger rideshare account, and wherein the safety feature includes at least one of an external door tamper alert, an internal door tamper alert, an unbuckled seatbelt alert, and an air quality alert.

9. The method of claim 1, further comprising establishing a communication link between an interior cabin of the autonomous vehicle and a primary passenger rideshare application.

10. The method of claim 1, further comprising defining a geofenced area for the autonomous vehicle during the stop duration.

11. The method of claim 1, further comprising establishing a connection with a passenger rideshare account and transmitting vehicle information to the passenger rideshare account.

12. A system for addition of a supervised stop to an autonomous vehicle route, comprising:
a central computing system including a routing coordinator configured to:
receive a ride request including a pick-up location and a destination location, and
select an autonomous vehicle to fulfill the ride request;
a plurality of sensors in a cabin of the autonomous vehicle; and
an onboard computing system on the autonomous vehicle configured to:
direct the autonomous vehicle to the pick-up location for pick up of a plurality of passengers, wherein the plurality of passengers include a primary passenger and a secondary passenger;
receive a supervised stop request, wherein the supervised stop request includes a stop location and a stop duration;
direct the autonomous vehicle to drop off the primary passenger at the stop location; and
supervise the secondary passenger during the stop duration, wherein supervising the secondary passenger includes:
detecting, based on data from the plurality of sensors, a secondary passenger event, and
responding to the secondary passenger event.

13. The system of claim 12, wherein the central computing system is further configured to receive the supervised stop request, and send the supervised stop request to the autonomous vehicle.

14. The system of claim 12, wherein the plurality of sensors are passive sensors and wherein the onboard computing system is configured to use the data from the plurality of sensors to detect the secondary passenger event by detecting at least one of a selected word, a selected phrase, and noise exceeding a selected sound level threshold.

15. The system of claim 12, wherein the onboard computing system is further configured to respond to the secondary passenger event by at least one of notifying the primary passenger and using a voice assistant intermediary to respond to the second passenger.

16. The system of claim 12, wherein the central computing system includes a database having primary passenger rideshare account information, and wherein the primary passenger rideshare account information includes secondary passenger profile information, and supervision settings for supervised stops.

17. The system of claim 16, wherein the onboard computing system is further configured to identify the second passenger based on image data from the plurality of sensors and based on the secondary passenger profile information.

18. An autonomous vehicle for providing supervision during an intermediate stop, comprising:
a plurality of sensors positioned within in an interior cabin;
a screen configured to display video;
an onboard computing system configured to:
receive ride request information including a pick-up location and a destination location;
direct the autonomous vehicle to the pick-up location for pick up of a plurality of passengers, wherein the plurality of passengers include a primary passenger and a secondary passenger;
receive a request for a supervised stop through a primary passenger rideshare account, wherein the supervised stop request includes a stop location and a stop duration;
direct the autonomous vehicle to drop off the primary passenger at the stop location; and
supervise the secondary passenger during the supervised stop, wherein supervising the secondary passenger includes:
detecting, based on data from the plurality of sensors, a secondary passenger event, and
responding to the secondary passenger event.

19. The autonomous vehicle of claim 18, wherein the plurality of sensors are passive sensors and wherein the onboard computing system is configured to use the data from the plurality of sensors to detect the secondary passenger event by detecting at least one of a selected word, a selected phrase, and noise exceeding a selected sound level threshold.

20. The autonomous vehicle of claim 17, wherein the screen is configured to provide communication between a primary passenger rideshare account and a secondary passenger during the supervised stop.
